(19) United States
(12) Patent Application Publication
(10) Pub. No.: US 2002/0103874 A1
(43) Pub. Date: Aug. 1, 2002

(54) Visual information organization and communication

(76) Inventor: Christopher Woods, Santa Monica, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/061,024

(22) Filed: Jan. 28, 2002

Related U.S. Application Data
(60) Provisional application No. 60/264,525, filed on Jan. 26, 2001.

(51) Int. Cl. G06F 15/167; G06F 15/16; G06F 17/30; G06F 7/00

(52) U.S. Cl. 709/212; 709/203; 707/10

(57) ABSTRACT

A visual information system. In one embodiment the visual information system is a computer system storing visual presentations indexed by time and location. In a further embodiment the visual information system includes facilities for providing voice-overs for the visual presentations.

### CROSS-REFERENCE TO RELATED APPLICATIONS

This application claims the benefit of U.S. Provisional Application No. 60/264,525 entitled Visual Information Organization and Communication, filed Jan. 26, 2001, the disclosure of which is incorporated by reference.

### BACKGROUND OF THE INVENTION

The present invention relates generally to visual information, and more particularly to storage, retrieval, and communication of visual information.

Computers allow for storage and retrieval of large quantities of information. The storage capabilities of memory devices and components has increased tremendously. The ability of electronic processing systems to index and process the stored information has perhaps grown at even a more tremendous rate.

When computers and memory devices are connected in a network, the capabilities of those computers to store and retrieve information is increased through access to additional sources of information. Perhaps more importantly, the tying of computers into networks has vastly increased the ease of communication between the computers, particularly communication of information stored by devices associated with computers remote to a user of a computer requesting the information.

Much of the information stored is textual in nature. Much of the information transferred between users of computers is also textual in nature. Often information important to people, however, is not textual in nature, it is visual. This is not surprising as the world around us is visual in nature, and perhaps the majority of the information received by people is visual in nature. Moreover, the memories of people themselves are often visual in nature.

Thus, it would seem that computers do not store or transfer information which is adapted to the users of that information.

Further, users often associate information with times and locations. In other words, users reference information, often visual in nature, in time and physical space. Computers often do not organize information in a such a manner. Instead, computers often store non-visual information in ways not suited for time and location retrieval.

### SUMMARY OF THE INVENTION

The present invention provides a visual information organization and communication system and method and a system and method for the storage and selection of visual information, particularly with respect to time and space. The present invention further provides for communication of visual information. Visual information may include audio descriptions and be referenced by time and/or location, and also according to written textual notes. Visual information is indexed by title and date, as well as searchable through the other selections. The system and method allows for transmission of a single visual segment to another user, or transmission of a set or series of visual segments so as to provide increased communication capability between users.

These and other aspects of the present invention will be more readily understood with respect to the attached figures viewed in conjunction with the following descriptions. Additional information may be found in U.S. Provisional Patent Application INFORMATION PROVISIONING, REVIEW AND MODIFICATION, Application No. 60/225,446, filed Aug. 14, 2000, the disclosure of which is incorporated by reference herein.

### BRIEF SUMMARY OF THE INVENTION

The present invention provides a visual information systems and methods. In one aspect the present invention comprises a method of storing visual information comprising storing a plurality of visual images; storing spatial information linked with each of the visual images, the spatial information associating each of the visual images with a geographic location; and storing temporal information linked with each of the visual images, the temporal information associating each of the visual images with a time.

In a further aspect the invention comprises an information system for organizing visual information, the system comprising memory storing a plurality of visual images; a digital recording system including a computer, associated memory, an input device for receiving audio information, and software for receiving data provided by the input device and storing the data in memory, the data being indexed to at least one of the plurality of visual images.

In a further aspect the invention comprises a time/location visual information system comprising means for storing a plurality of visual presentations; means for linking some of the plurality of visual presentations to form a linked set of visual presentations; and means for associating a time and location to the linked set of visual presentations.

These and other aspects of the present invention will be more readily comprehended upon review of the following discussion viewed in conjunction with the accompanying figures.

### BRIEF DESCRIPTION OF THE DRAWINGS

FIG. 1 is a grouping screen in accordance with aspects of the present invention;

FIG. 1a is a system in accordance with aspects of the present invention;

FIG. 2 is a clip screen in accordance with aspects of the present invention;

FIG. 3 is a further clip screen in accordance with aspects of the present invention;

FIG. 4 is a clip screen in accordance with aspects of the present invention;

FIG. 5 is an upload screen in accordance with aspects of the present invention;

FIG. 6 is a further upload screen in accordance with aspects of the present invention;

FIG. 7 is a further clip screen in accordance with aspects of the present invention;

FIG. 8 is a mail screen in accordance with aspects of the present invention.

### DETAILED DESCRIPTION

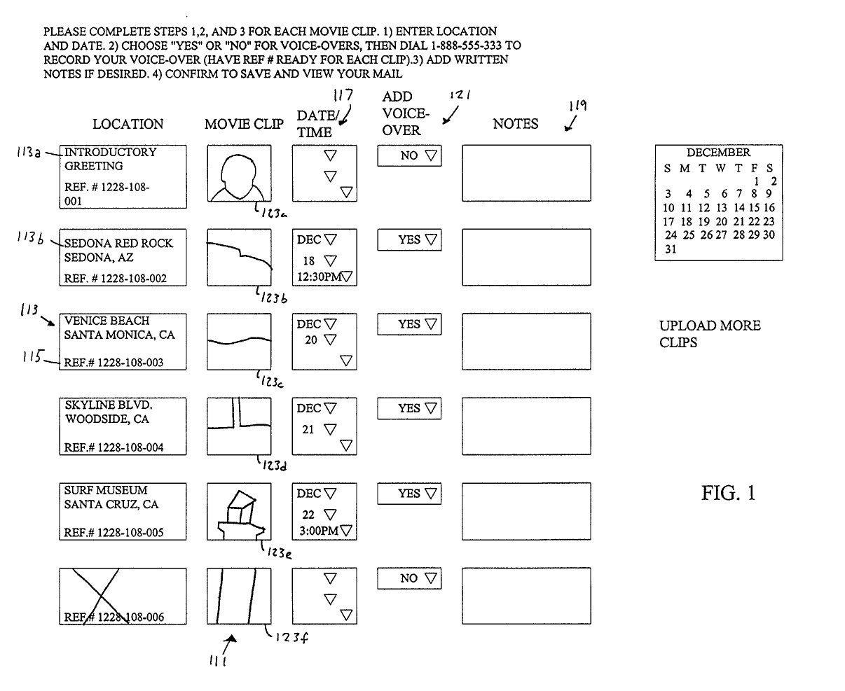

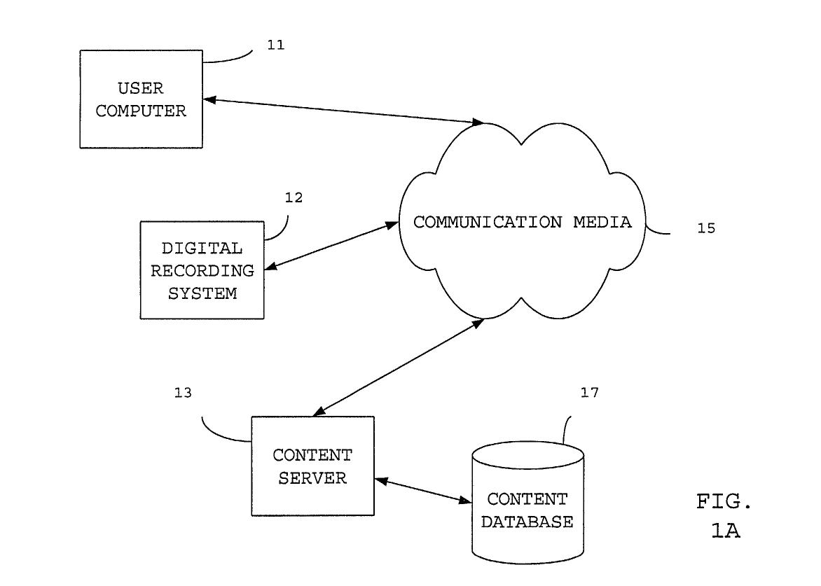

FIG. 1 illustrates a grouping screen in accordance with aspects of the present invention. The grouping screen includes a number of thumbnail images 111 indicative of a visual presentation, which in many cases comprises visual imagery. Each of the thumbnail images represents, and provides access to, a visual presentation.

Associated with each thumbnail image are a plurality of items of associated information. A first item of associated information is a location/title 113 associated with the visual presentation. The location/title indicates either an indicative title 113a for the visual presentation or a specific location 113b associated with the visual presentation. Also associated with each visual presentation is a unique reference number 115, with the reference number allowing for unique storage identification in a digital format.

Also associated with each visual presentation is a time period 117. A time is specific to the visual presentation, and generally relates to the visual presentation. The time field as well as the location field, when the title/location entry is indicated as a location, locates the visual presentation in both time and space.

Further associated with each visual presentation is a notes field 119. The notes field is a text-based field. The notes field provides for additional information regarding the visual presentation as well as an aid in searching for specific visual presentations when searches are conducted text-based search engines.

Visual presentation optionally have an associated audio supplement, or voice-over 121. Voice-overs are played along with visual presentations, thereby providing audio/visual presentations. Voice-overs in one embodiment are accomplished using audio/visual camera recording devices.

In a further embodiment voice-overs are generated using external reception and storage sources. Thus, in one embodiment voice-overs are generated by way of a telephone call by a user to a digital recording system 12 (shown in FIG. 1a) accessible at a specified phone number. Upon calling the specified phone number the user is prompted to provide a reference number associated with a visual presentation to which the user desires to associate a voice-over. The reference number is preferably entered by way of the telephone keypad, although in various embodiments voice recognition methods are used.

The user is thereafter prompted to begin the voice-over. Preferably, the user simultaneously views the visual presentation simultaneously with recording the voice-over, with synchronization occurring by way of the user beginning both the voice over and local presentation of the visual presentation in response to the prompt to begin the voice-over. During the voice-over the digital recording system stores the voice-over in digital format in a digital memory.

Completion of the voice-over is indicated when the user depresses specified telephone keypad buttons, which may be simply any telephone keypad entry. In one embodiment the digital memory is memory accessible to a node on a network reachable by the user, and the voice-over is conveniently maintained in the digital memory. In other embodiments, however, the contents of the digital memory are transferred to other digital memory, which is appropriately indexed for retrieval by the user.

FIG. 1a illustrates a block diagram of a network in accordance with aspects of the present invention. In the network a user computer 11 is linked to a number of computers. In the described embodiment, the user computer comprises a personal computer (PC). In alternative embodiments, however, the user computer comprises an engineering work station, such as a SPARC machine for other systems supporting web based communications and display functions. In one embodiment, the user computer is a low cost machine specially designed for internet browsing.

The user computer is linked, via a network 15 including telephone lines, including ISDN, ADSL, DSL lines, and the like, linked to the computer network. Alternatively, the user computer is linked via cable connections using cable modems, or wireless connections, such as radio frequency transmissions and select transmissions, or via other known communication methods to the computer network.

The user computer includes a web browser. The web browser requests information from other computers, particularly web servers for display on display terminal of the user computer. The web browser obtains a copy of the requested material by forming and transmitting a hypertext transfer protocol (HTTP) request to a web server.

The network also includes a content development server 13. The content development server comprises a web server, with the web server responding to HTTP requests from the user computer. In one embodiment, the content development server is a computer having a memory, mass memory storage, network interface cards, and associated items, and operates under a UNIX-based operating system. The network includes an information provider server 12. The information provider server comprises a web server, with the web server responding to HTTP requests from the user computer. In one embodiment, the information provider server is a computer having a memory, mass memory storage, network interface cards, and associated items, and operates under a UNIX-based operating system. The information provider server interacts with a content database. The content database is stored on a mass storage device such as a hard disk drive, a redundant array of independent disks (RAID), or a group of disks sometimes referred to as “just a bunch of disks” (JBOD). The content development server is configured to access the database to retrieve information, particularly items of content. Items of content include, in particular, video imagery and associated schematics and positional information.

In the embodiment of FIG. 1a the network further includes a digital recording system 12. The digital recording system includes a computer, associated memory, an input device for receiving audio, and appropriate software for receiving data from the input device and storing the data, potentially specially formatted, in the associated memory.

Returning now to FIG. 1, the visual presentations of FIG. 1 form a linked set of visual presentations. In various embodiments the linking of the visual presentations occurs in different ways. For example, in one embodiment the linking of visual presentations occurs through explicit selection of the visual presentations. In another embodiment the linking of visual presentations occurs through selection of a time period. Indeed, in differing embodiments linking of visual presentations occurs through criteria based on any of the items associated with a visual presentation.

As illustrated, the thumbnail images in FIG. 1 relate to a four day period of time in which a pair of people, including the user, traveled to four different locations. Four of the visual representations referenced by thumbnail images 123b-e relate to one of the four locations, respectively. A fifth visual presentation referenced by a thumbnail image 123a provides an explanatory overview of the other visual presentations. A sixth thumbnail image is marked for deletion 123f.

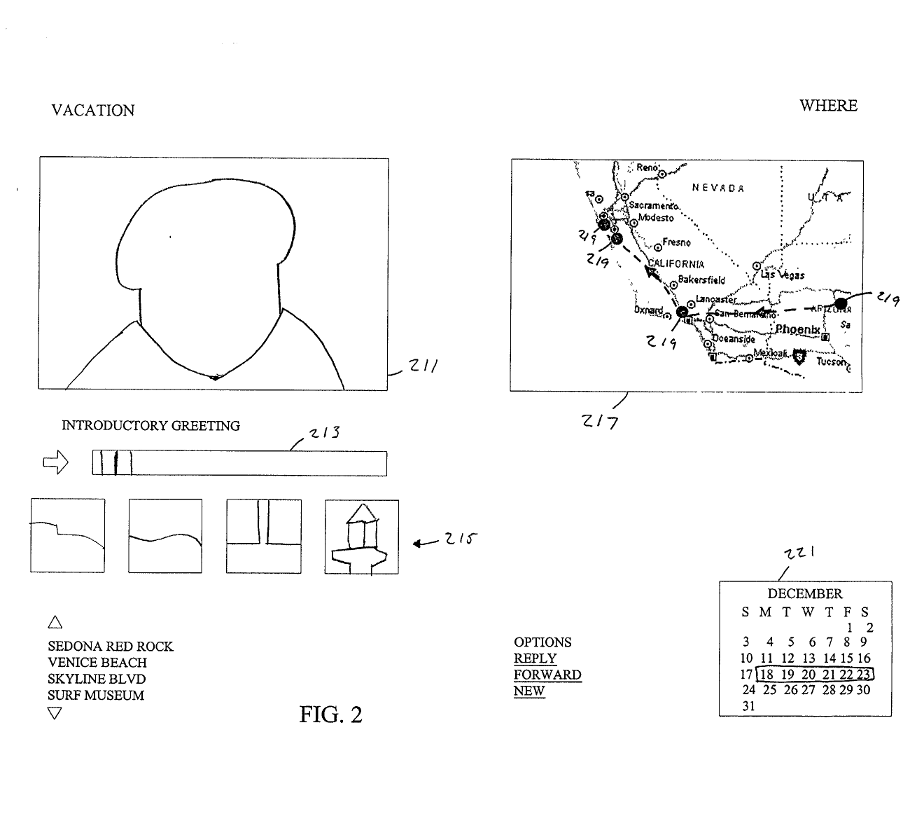

FIG. 2 is a snapshot of a visual presentation associated with the explanatory overview. The visual presentation associated with the explanatory overview is therefore, as illustrated in FIG. 2, the referenced, or primary, visual presentation 211. The visual presentation includes video imagery with a voice-over. The video imagery is recorded, for example, using a digital video camera. The video imagery is comprised of a number of video images which play consecutively. The voiceover plays with the video imagery. A scroll bar 213 indicates playing of the video imagery, and the play indicator of the scroll bar may be moved, for example through a click and drag operation using a computer mouse, to various frames making up the video imagery. Movement of the play indicator also moves an index into the voice-over.

The other thumbnail images 215 representing visual presentations in the group of visual presentations is also displayed along with the reference video presentation. The titles of the other visual presentations are also displayed. Selection of either a thumbnail image or of the title of the thumbnail images results in the visual presentation associated with the thumbnail image becoming the referenced, or primary, thumbnail image. Accordingly, a specific visual presentation may be selected using either a video image or a textual indication.

A specific visual presentation may also be selected using a geographic indication. A geographic representation 217 of the locations is displayed along with the video imagery to allow such selection, as well as to provide a location based reference for the visual presentation.

As illustrated in FIG. 2 the geographic representation is a map. The map includes selectable location indicators 219, with each location indicator being a site associated with a visual presentation. Placement of a cursor over a location indicator, or of the corresponding thumbnail image or textual reference, results in the location indicator, thumbnail image, and textual reference all being highlighted. Thus, movement of the cursor allows for visual, geographic, and textual cues as to the content of a visual presentation.

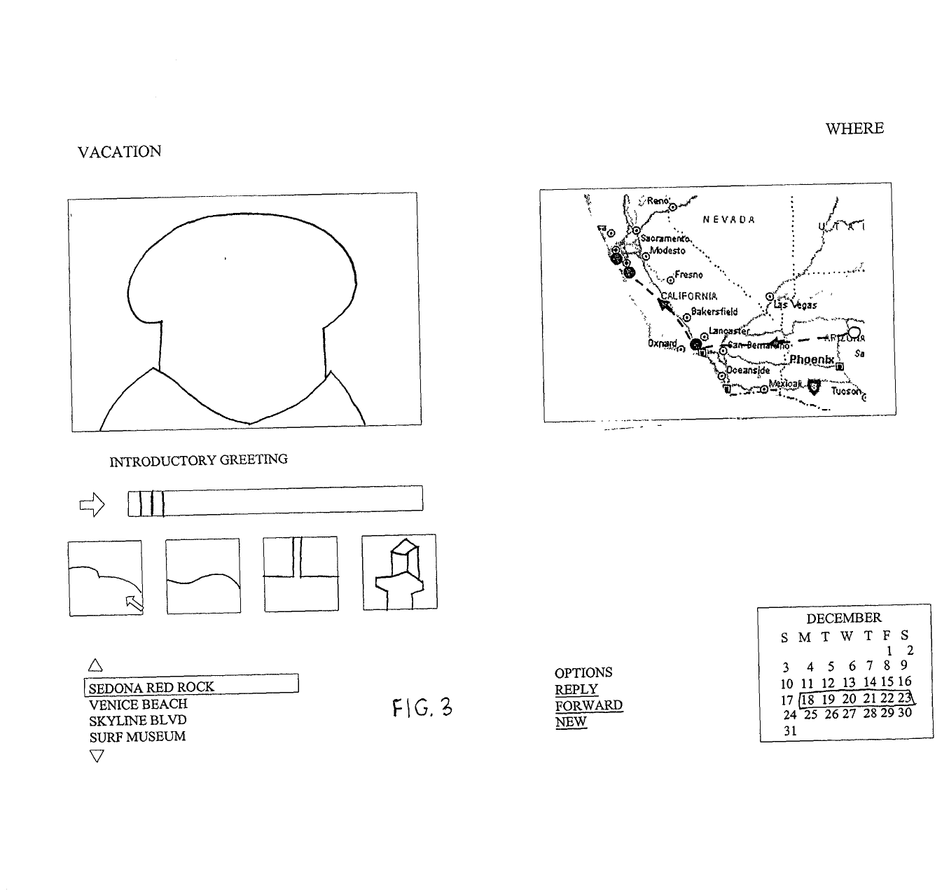

The visual presentation also provides a calendar display 221. The dates associated with the visual presentation are highlighted. Placement of the cursor as previously described, may also be accomplished using the calendar, and with similar effect. Such placement of the cursor and the results thereof are illustrated in FIG. 3. As illustrated the highlighting of the calendar display is unchanged through use of the cursor, although in alternative embodiments the calendar display highlights to indicate a date or dates associated with the visual presentation referenced by the cursor.

Similarly, in alternative embodiments a calendar is also provided on the group display of FIG. 1. The calendar display of FIG. 1 is caused to similarly respond as previously described. In addition, in a further embodiment the calendar display also allows for the display of alternative groups of visual presentations associated with alternative days.

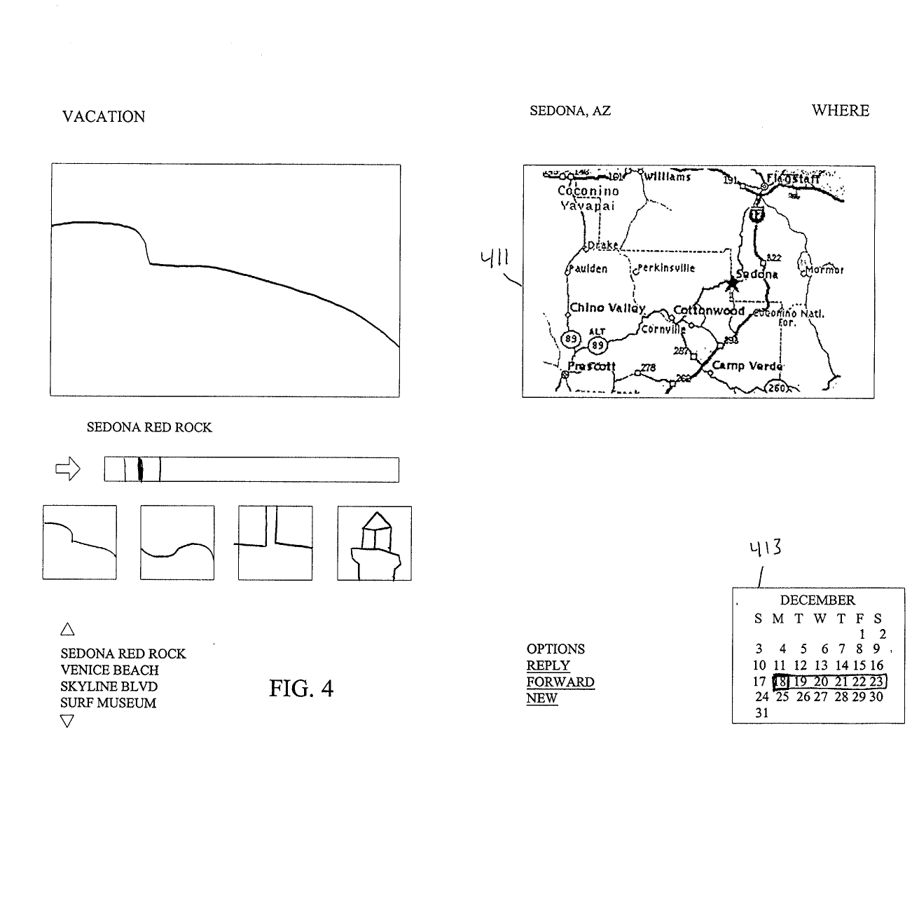

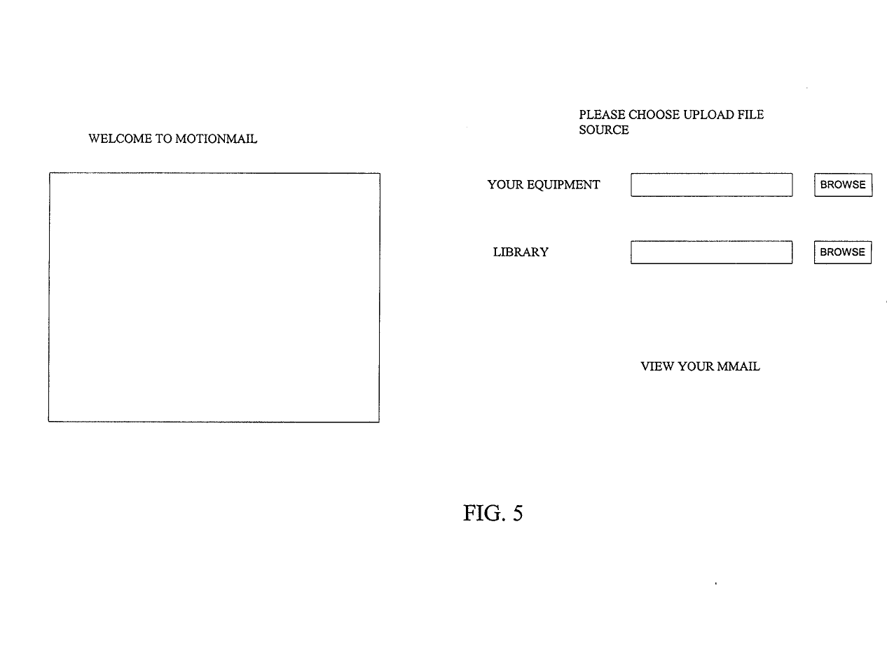

FIG. 4 illustrates a visual presentation associated with another thumbnail image. The visual presentation is associated with a geographic location, Sedona, Ariz., and a date, December 18. The location of Sedona is indicated on a map display 411. The date is indicated on a calendar 413. The video imagery associated with the visual presentation may be taken with, for example, a digital video camera, and taken by the user. The video imagery is uploaded into computer memory storage through specification by the user of the type of equipment used to take the video imagery. An input screen for accomplishing this is illustrated in FIG. 5.

In one embodiment the video imagery is stored on the user's local memory. In an alternative embodiment the video imagery is stored on a centrally accessible memory, and is indexed by time and location. Storage on the centrally accessible memory allows for use of the video imagery by other users. For the video imagery of FIG. 4, for example, the user did not take the video imagery. Instead, the user selected video imagery of Sedona from a library of video imagery.

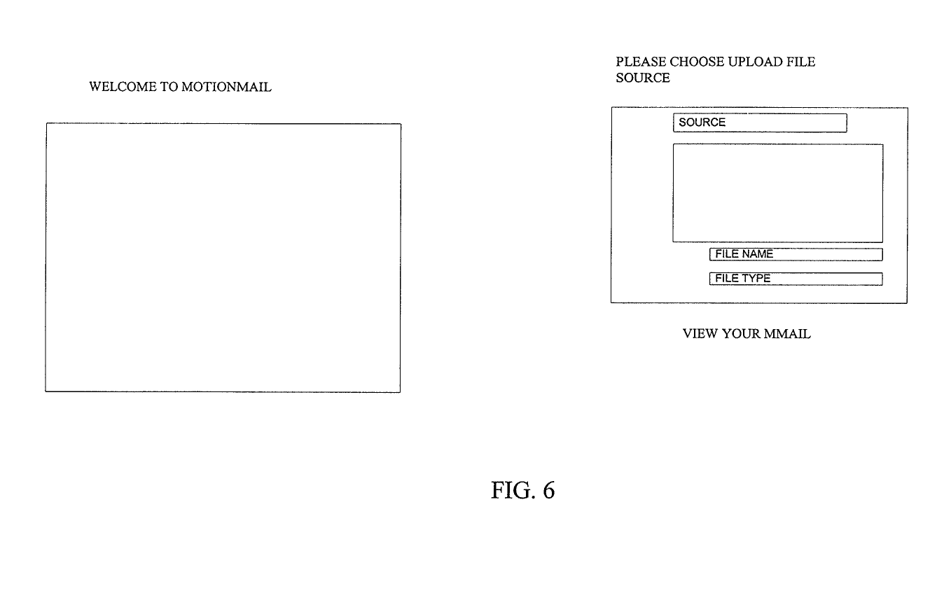

In one embodiment this is accomplished using a familiar pop-up type window indicating file names, as illustrated in FIG. 6. In an alternative embodiment, however, selection of the video imagery is accomplished using a “drill-down” approach on a geographic representation display. For example, the video imagery of Sedona may be accomplished by initially selecting a map of the United States. A portion of the map of the United States is then selected, either by outlining a desired portion or by selecting a predefined portion, which results in display of a smaller scale map. This process is repeated until a map allowing for the selection of Sedona is provided. Selection of Sedona results in the display of thumbnail images of video imagery associated with Sedona, which may be perused and selected for inclusion at the user's option. Thus, users may make use of video imagery of others, which may be of the highest visual and artistic quality, and allow users to make use of the system without the necessity of taking video imagery or investing in video imagery equipment.

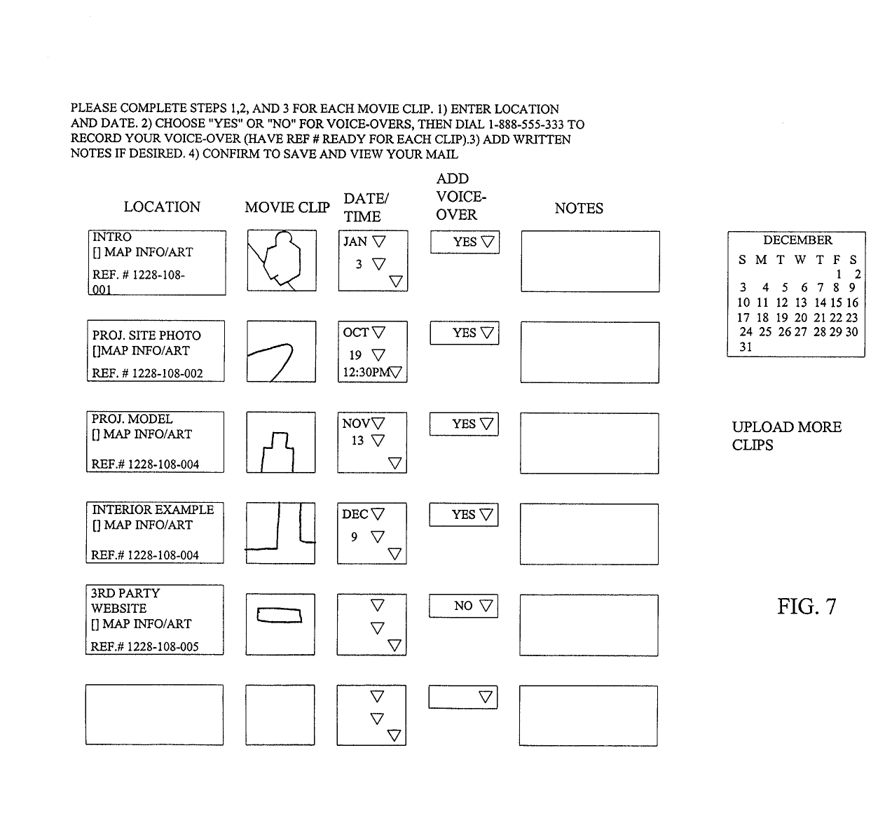

FIG. 7 illustrates another group of visual presentations. The visual presentations of FIG. 7, however, form a multimedia presentation. The multimedia presentation may be used for sales or other presentations. As with the group of visual presentations of FIG. 1, the multimedia presentation of FIG. 7 may be electronically mailed to a recipient through selection of a mail button (not shown).

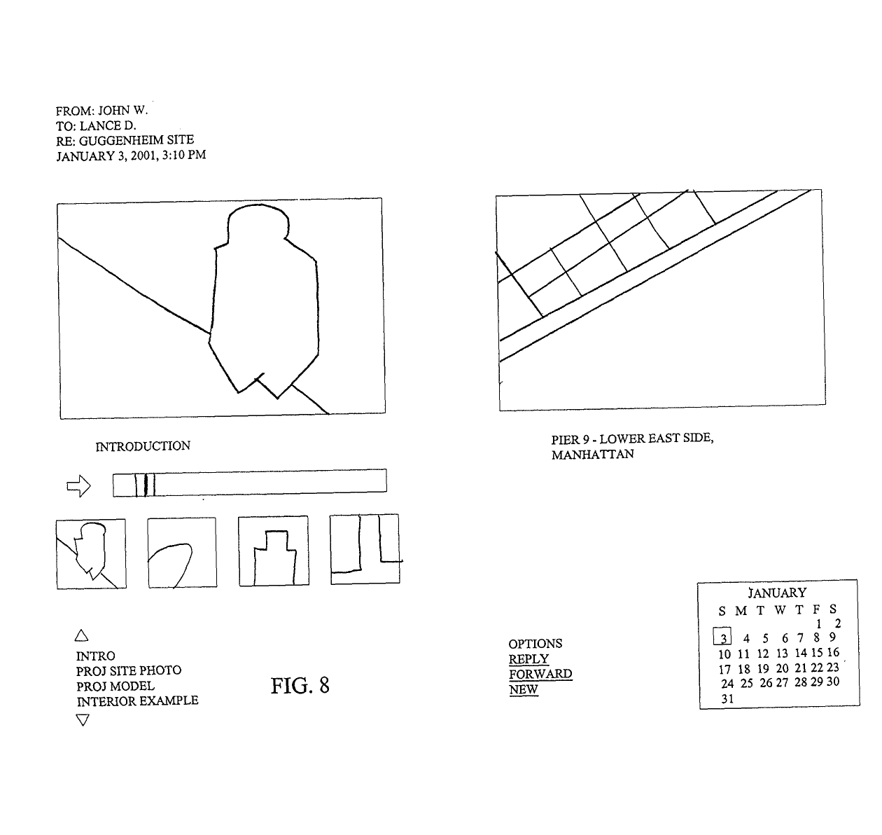

FIG. 8 illustrates a visual presentation of the group of visual presentations of FIG. 7. Operation of the visual presentation of FIG. 8 is similar to those as previously described. Notably, the use of the electronic mail feature provides benefits in that the multimedia presentation may be easily transmitted to recipients, who may view the multimedia presentation at their leisure. Moreover, the multimedia presentation is referenced in time and/or space, allowing for easier recall by the recipient of the nature and content of the multimedia presentation. In addition, as described with respect to the other figures, formation of the multimedia presentation may be easily accomplished, and potentially with publicly available video imagery.

Although the present invention has been described with respect to certain specific embodiments, it should be recognized that aspects of the present invention may be practiced otherwise than as specifically discussed. Accordingly, the present invention should be recognized as defined by the claims and their equivalents supported by disclosure, and not necessarily by the specific embodiments described herein.

1. A method of storing visual information comprising:
storing a plurality of visual images;
storing spatial information linked with each of the visual images, the spatial information associating each of the visual images with a geographic location; and
storing temporal information linked with each of the visual images, the temporal information associating each of the visual images with a time.

2. The method of storing visual information of claim 1 further comprising a method of accessing visual information, the method comprising:
receiving an indication of a geographic location;
determining the visual images with linked spatial information corresponding to the geographic location; and
accessing the visual images with linked spatial information corresponding to the geographic location.

3. The method of storing visual information of claim 1 further comprising a method of accessing visual information, the method comprising:
receiving an indication of a time;
determining the visual images with linked temporal information corresponding to the time; and
accessing the visual images with linked temporal information corresponding to the time.

4. The method of storing visual information of claim 1 further comprising a method of accessing visual information, the method comprising:
receiving an indication of a geographic location;
receiving an indication of a time;
determining the visual images with linked spatial information corresponding to the geographic location;
determining the visual images with linked temporal information corresponding to the time; and
accessing the visual images with linked spatial information corresponding to the geographic location and with linked temporal information corresponding to the time.

5. The method of claim 4 further comprising storing voice information linked with at least some of the visual images.

6. The method of claim 5 wherein storing voice information with at least some of the visual images comprises:
receiving an image reference indicating a visual image; and
receiving audio information;
storing the audio information; and
linking the audio information to the visual image for storage in association with visual image indicated by the image reference.

7. The method of claim 6 wherein the audio information is received over a phone line.

8. The method of claim 7 wherein the image reference is provided over the phone line.

9. The method of claim 8 wherein the image reference comprises tones.

10. The method of claim 5 wherein title information and notes information are linked with each of the visual images.

11. An information system for organizing visual information, the system comprising:
memory storing a plurality of visual images;
a digital recording system including a computer, associated memory, an input device for receiving audio information, and software for receiving data provided by the input device and storing the data in memory, the data being indexed to at least one of the plurality of visual images.

12. The information system of claim 11 wherein the memory storing a plurality of visual images is external to the digital recording system.

13. The information system of claim 11 wherein the memory storing a plurality of visual images is associated with a user's computer.

14. The information system of claim 11 wherein the input device for receiving audio information is adapted to receive audio information over a phone line.

15. The information system of claim 14 wherein the audio information includes tones indicative of a one of the plurality of visual images.

16. The information system of claim 15 wherein the tones indicative of a one of the plurality of visual images corresponds to a reference number.

17. The information system of claim 16 wherein information indicative of a geographic location is indexed to the plurality of visual images.

18. The information system of claim 17 wherein information indicative of a time is indexed to the plurality of visual images.

19. The information system of claim 18 wherein the plurality of visual images form a linked set of visual presentations.

20. A time/location visual information system comprising:
means for storing a plurality of visual presentations;
means for linking some of the plurality of visual presentations to form a linked set of visual presentations; and
means for associating a time and location to the linked set of visual presentations.
